(19) United States
(12) Patent Application Publication
(10) Pub. No.: US 2007/0076001 A1
(43) Pub. Date: Apr. 5, 2007

(54) Method for selecting a low dimensional model from a set of low dimensional models representing high dimensional data based on the high dimensional data

(76) Inventor: Matthew E. Brand, Newton, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/241,187

(22) Filed: Sep. 30, 2005

(51) Int. Cl. G06T 11/20

(52) U.S. Cl. 345/440

(57) ABSTRACT

A model of a class of objects is selected from a set of low-dimensional models of the class, wherein the models are graphs, each graph including a plurality of vertices representing objects in the class and edges connecting the vertices. First distances between a subset of high-dimensional samples of the objects in the class are measured. The first distances are combined with the set of low-dimensional models of the class to produce a subset of models constrained by the first distances and a particular model having vertices that are maximally dispersed is selected from the subset of models.

### FIELD OF THE INVENTION

The invention relates generally to modeling sampled data, and more particularly, to representing high-dimensional data with low-dimensional models.

### BACKGROUND OF THE INVENTION

As shown in FIG. 1, nonlinear dimensionality reduction (NLDR) generates a low-dimensional representation 120 from high-dimensional sampled data 101. The data 101 sample a d dimensional manifold [symbol] 105 that is embedded in an ambient space [symbol] ^{D} 110, with D>d. The goal is to separate 115 the extrinsic geometry of the embedding, i.e., how the manifold [symbol] 105 is shaped in the ambient space [symbol] ^{D}, from its intrinsic geometry, i.e., the d-dimensional coordinate system 120 of the manifold [symbol] The manifold can be represented 104 as a graph having vertices 125 connected by edges 130, as is commonly understood in the field of graph theory. The vertices 125 represent sampled data points 101 on the manifold in the high dimensional coordinate system and the edges 130 are lines or arcs that connect the vertices 125. Thus, the graph is embedded in the manifold. The term graph should not be confused with a graph of a function as in analytic geometry, i.e., a plot.

For example, if it is known how a manifold of objects, such as human faces, is embedded in a ambient space of images of the faces, then the intrinsic geometry of a model can be used to edit, compare, and classify images of faces, while the extrinsic geometry can be used to detect faces in images and synthesize new images of faces.

As another example, a manifold of vowel sound objects embedded in a space of speech sounds can be used to model the space of acoustic variations in the vowel sounds, which can be used to separate classes of vowel sounds.

Known spectral methods for generating a low-dimensional model of high dimensional data by embedding graphs and immersing data manifolds in low-dimensional spaces are unstable due to insufficient and/or numerically ill-conditioned constraint sets.

Embedding a graph under metric constraints is a frequent operation in NLDR, ad-hoc wireless network mapping, and visualization of relational data. Despite advances in spectral embedding methods, prior art NLDR methods are impractical and unreliable. One difficulty associated with NLDR is automatically generating embedding constraints that make the problem well-posed, well-conditioned, and solvable on practical amount of time. Well-posed constraints guarantee a unique solution. Well-conditioned constraints make the solution numerically separable from sub-optimal solutions.

Both problems manifest as a small or zero eigengap in the spectrum of the embedding constraints, indicating that the graph, i.e., the model, is effectively non-rigid and there is an eigen-space of solutions where the optimal solution is indistinguishable from other solutions. Small eigengaps make it difficult or even impossible to separate a solution from its modes of deformation.

Graph Embeddings

In Laplacian-like local-to-global graph embeddings, the embedding of each graph vertex is constrained by the embeddings of immediate neighbors of the vertex, i.e., in graph theory terminology, the 1-ring of the vertex. For dimensionality reduction, the vertices are data points that are sampled from a manifold that is somehow ‘rolled-up’ in the ambient high-dimensional sample space, and the graph embedding constraints are designed to reproduce local affine structure of that manifold, while ‘unrolling’ the manifold in a lower dimensional target space.

Prior art examples of local-to-global graph embeddings include Tutte's method, see W. T. Tutte, “How to draw a graph,” Proc. London Mathematical Society, 13:743-768, 1963, Laplacian eigenmaps, see Belkin et al., “Laplacian eigenmaps for dimensionality reduction and data representation,” volume 14 of Advances in Neural Information Processing Systems, 2002, locally linear embeddings (LLE), see Roweis et al., “Nonlinear dimensionality reduction by locally linear embedding,” Science, 290:2323-2326, Dec. 22, 2000, Hessian LLE, see Donoho et al., “Hessian eigenmaps,” Proceedings, National Academy of Sciences, 2003, charting, see Brand, “Charting a manifold,” Advances in Neural Information Processing Systems, volume 15, 2003, linear tangent-space alignment (LTSA), see Zhang et al., “Nonlinear dimension reduction via local tangent space alignment,” Proc., Conf. on Intelligent Data Engineering and Automated Learning, number 2690 in Lecture Notes on Computer Science, pages 477-481, Springer-Verlag, 2003, and geodesic nullspace analysis (GNA), see Brand, “From subspaces to submanifolds,” Proceedings, British Machine Vision Conference, 2004.

The last three methods referenced above construct local affine constraints of maximal possible rank, leading to substantially stable solutions.

LTSA and GNA take an N-vertex graph embedded in an ambient space R^{D} with vertex positions X=[x₁, . . . ,x_{N}]∈R^{D×N}, and re-embed the graph in a lower-dimensional space R^{d} with new vertex positions Y=[y₁, . . . ,y_{N}]∈R^{d×N}, preserving local affine structure. Typically, the graph is constructed from point data by some heuristic, such as k-nearest neighbors.

The embedding works as follows. Take one such neighborhood of k points and construct a local d-dimensional coordinate system Xₘ≐[xᵢ,xⱼ, . . . ]∈R^{d×k}, using, for example, local principal components analysis (PCA). The PCA produces a nullspace matrix Qₘ∈R^{k×(k-d-1)}, having orthonormal columns that are orthogonal to the rows of coordinate system Xₘ and to a constant vector 1. This nullspace is also orthogonal to any affine transform A(Xₘ) of the local coordinate system, such that any translation, rotation, or stretch that preserves parallel lines in the local coordinate system will satisfy A(Xₘ)Qₘ=0. Any other transform T(Xₘ) can then be separated into an affine component A(Xₘ) plus a nonlinear distortion, N(Xₘ)=T(Xₘ)QₘQₘ^{T}.

The LTSA and GNA methods assemble the nullspace projectors QₘQₘ^{T}, m=1,2, . . . into a sparse matrix K∈R^{N×N} that sums (LTSA) or averages with weights (GNA) nonlinear distortions over all neighborhoods in the graph.

Embedding basis V∈R^{d×N} has row vectors that are orthonormal and that span the column nullspace of [K,1]; i.e., VV^{T}=I and V[K,1]=0. It follows that if an embedding basis V exists and is provided as a basis for embedding the graph in R^{d}, then each neighborhood in that embedding will have zero nonlinear distortion with respect to its original local coordinate systems, see Zhang, et al., above.

Furthermore, if the neighborhoods are sufficiently overlapped to make the graph affinely rigid in R^{d}, the transform from the original data X to the embedding basis V ‘stretches’ every neighborhood of the graph the same way. Then, a linear transform T∈R^{d×d} removes the stretch, giving lower-dimensional vertex positions Y=TV, such that the transform from higher dimensional data X to lower dimensional embedding Y involves only rigid transforms of local neighborhoods, i.e., the embedding Y is isometric. When there is any kind of noise or measurement error in the process, a least-squares optimal approximate embedding basis V can be obtained via thin singular value decomposition (SVD) of K∈R^{N×N} or thin eigenvalue decomposition (EVD) of the null space of K, i.e., KK^{T}. Because matrix K is very sparse with O(N) nonzero values, iterative subspace estimators typically exhibit O(N) time scaling. When sparse matrix K is constructed using GNA, the corresponding singular values s_{N-1},s_{N-2}, . . . measure the point wise average distortion per dimension.

One of the central problems of prior art graph embedding is that the eigenvalues of KK^{T}, and of any constraint matrix in local NLDR, grow quadratically near λ₀=0, which is the end of the spectrum that furnishes the embedding basis V, see Appendix A for a proof of the quadratic growth of the eigenvalues of KK^{T}. Quadratic growth means that the eigenvalue curve is almost flat at the low end of the spectrum (λᵢ₊₁−λᵢ≈0) such that an eigengap that separates the embedding basis from other eigenvectors is negligible. A similar result is observed in the spectra of simple graph Laplacians, which are also sigmoidal with a quadratic growth near zero.

In graph embeddings, the constraint matrix plays a role akin to the stiffness matrix in finite-element methods, and in both cases the eigenvectors associated with near-zero eigenvalues specify an optimal parameterization, i.e., the solution, and less optimal distorted modes of the solution, also known as ‘vibration’. The problem facing an eigensolver, or any other estimator of the nullspace, is that a convergence rate is a linear function of the relative eigengap

$$\frac{\vert {λ}_{c} - {λ}_{c + 1} \vert}{{λ}_{max} - {λ}_{min}}$$

or eigenratio

$$\frac{{λ}_{c + 1}}{{λ}_{c}}$$

between the desired and remaining principle eigenvalues, see Knyazev, “Toward the optimal preconditioned eigensolver,” SIAM Journal on Scientific Computing, 23(2):517-541, 2001. Numerical stability of the eigenvectors similarly depends on the eigengap. As stated described above, for local-to-global NLDR, the eigengap and eigenratio are both very small, making it difficult to separate the solution i.e., a best low-dimensional model of the high-dimensional data, from distorted modes of the solution i.e., vibrations.

Intuitively, low-frequency vibrations make very smooth bends in a graph, which incur very small deformation penalties at the local constraint level. Because eigenvalues of a graph sum those penalties, the eigenvalues associated with low-frequency modes of deformation have very small values, leading to poor numerical conditioning and slow convergence of eigensolvers. The problem increases in scale for larger problems where fine neighborhood structure makes for closely spaced eigenvalues, making it impossible for iterative eigensolvers to accurately determine the smallest eigenvalues and vectors representing an optimal best solution, i.e., a best model, having the least or no vibration.

Therefore, there is a need for a method for selecting a particular low-dimensional model from a set of low-dimensional models of a class of objects, where the set of low-dimensional models is derived from high dimensional sampled data.

### SUMMARY OF THE INVENTION

The invention select a particular model of a class of objects from a set of low-dimensional models of the class, wherein the models are graphs, each graph including a plurality of vertices representing objects in the class and edges connecting the vertices. First distances between a subset of high-dimensional samples of the objects in the class are measured. The first distances are combined with the set of low-dimensional models of the class to produce a subset of models constrained by the first distances and a particular model having vertices that are maximally dispersed is selected from the subset of models.

### BRIEF DESCRIPTION OF THE DRAWINGS

FIG. 1 is a block diagram of basic steps for non-linear dimensionality reduction;

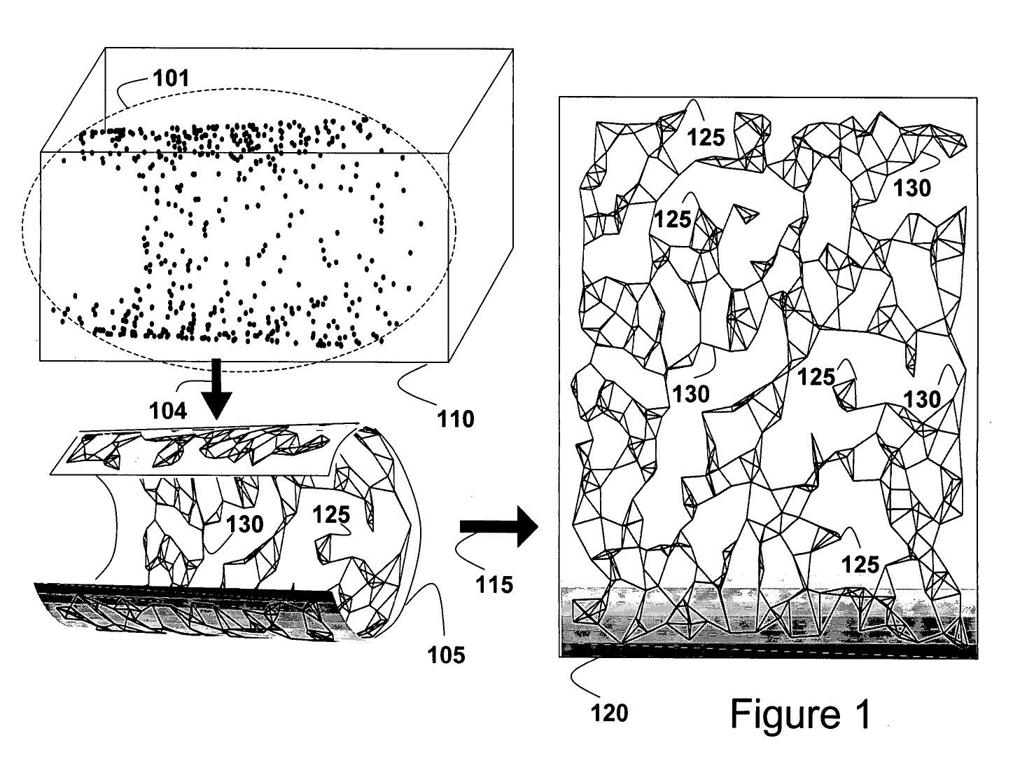

FIG. 2 is a block diagram of a prior art method for generating a set of low-dimensional models of a class of objects;

FIG. 3 is a block diagram of a method for selecting a particular model from a set of models representing a class of objects according to the invention;

FIG. 4 is a block diagram of recursive neighborhood expansion according to the invention;

FIG. 5 is a block diagram of a non-rigid graph representing a class of objects; and

FIG. 6 is a block diagram of a method for selecting a particular model from a set of low dimensional models representing a class of objects based on high dimensional data according to the invention.

### DETAILED DESCRIPTION OF THE PREFERRED EMBODIMENT

Generating an Input Class Model Using NLDR

The invention takes as input one of a set of low-dimensional models of objects, i.e., a set of local-to-global embedding representing the class of objects, described below in further detail. The set of models are generated using non-linear dimensionality reduction (NLDR). In the preferred embodiment, the set of models is generated using geodesic nullspace analysis (GNA) or, optionally, linear tangent-space alignment (LTSA), because all other known local-to-global embedding methods employ a subset of the affine constraints of LTSA and GNA.

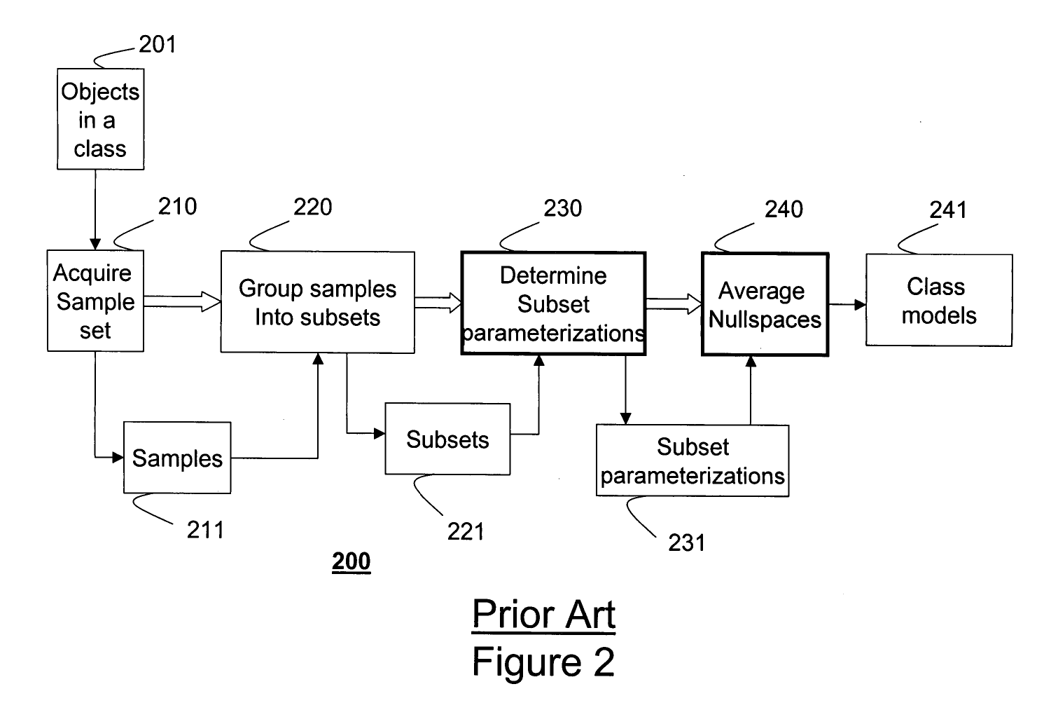

FIG. 2 shows a prior art method for generating a set of models 301 using geodesic nullspace analysis (GNA), which is described in U.S. patent application Ser. No. 10/932,791, “Method for Generating a Low-Dimensional Representation of High-Dimensional Data,” filed on Sep. 2, 2004, and owned by the assignee of the present application and incorporated herein by reference in its entirety. To generate the input set of models 301 using GNA, objects 201 in a class existing in a high-dimensional ambient space [symbol] ^{D} are sampled 210 from a d dimensional manifold embedded in the ambient space, where D>d, to produce a set of samples 211. For example, the samples 211 are images of the faces. There is at least one image (sample) for each face. Each sample includes multiple data values representing characteristics of the object, e.g., the pixel intensity values, perhaps in color, in the images. Thus, each sample can include many millions of data values. The data values for each sample are organized as a vector. For images, this can be done by conventional scan line conversion. The goal of NLRD is to separate the extrinsic geometry of the embedding. That is, it is desired to determine the shape of the manifold in the ambient space [symbol] ^{D} from the intrinsic geometry of the manifold, i.e., the native d-dimensional coordinate system on the manifold.

The manifold is locally isometric to an open subset of a target space [symbol] ^{d} and embedded in the ambient Euclidean space [symbol] ^{D}>d by an unknown quadratic function C². The manifold M is a Riemannian submanifold of the ambient space [symbol] ^{D}.

The manifold has an extrinsic curvature in the ambient space [symbol] ^{D}, but a zero intrinsic curvature. However, the isometric immersion of the manifold in the target space [symbol] ^{d} can have a nontrivial shape with concave boundaries.

The set of samples 211, represented by X≐[x₁, . . . ,x_{N}]∈ [symbol] ^{D×N}, records locations of N samples of the manifold in the ambient space [symbol] ^{D}.

An isometric immersion of the set of samples Y_{iSO}≐[y₁, . . . ,y_{N}] ∈ [symbol] ^{d×N} eliminates the extrinsic curvature of the set to recover the isometry up to rigid motions in the target space [symbol] ^{d}.

The samples 211 are grouped 220 into subsets of samples 221, i.e., neighborhoods, so that each subset overlaps with at least one other subset. Each subset of samples has k samples, where k can vary. The grouping 220 is specified by an adjacency matrix M=[mₗ, . . . ,m_{M}]∈ [symbol] ^{N×M} with Mₙₘ>0 if and only if the n^{th} point is in the m^{th} subset.

Subset parameterizations Xₘ ∈ [symbol] ^{d×k} 231 are determined 230 for each sample subset 221. The subset parameterizations 231 can contain a locally isometric parameterization of the k samples in the m^{th} subset. Euclidean pairwise distances in the parameterizations are equal to geodesic distances on the manifold.

When applying geodesic nullspace analysis, nullspaces of the isometric low-dimensional parameterizations are averaged 240 to obtain a matrix having a nullspace containing a set of low-dimensional models 301 of the class of objects. It is one goal of the invention to provide a method for selecting a particular model 331 from the set of models 301. It should be understood that each model in the set 301 can be represented by a graph of the objects in the lower-dimensional target space [symbol] ^{d}. The invention improves over prior art methods of selecting a particular model from the set 301.

Neighborhood Expansion

The invention effectively stiffens a mesh of vertices and edges of a graph, i.e., model, of the objects in the lower-dimensional target space [symbol] ^{d} with longer-range constraints applied to expanded subsets of vertices and edges in the graph of the d dimensional manifold embedded in the ambient space [symbol] ^{D}.

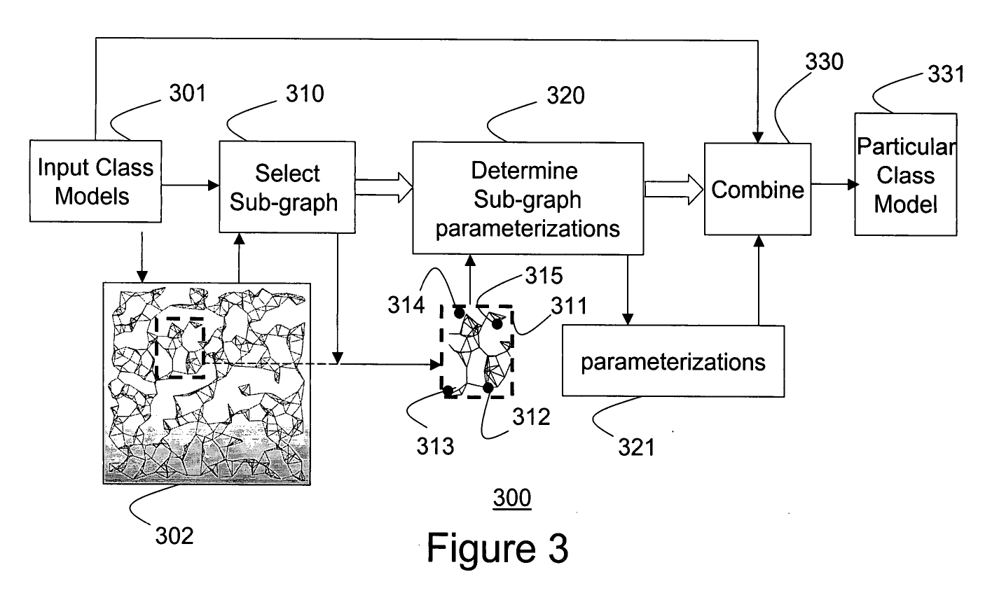

As shown in FIG. 3, a method 300 according to the invention groups 310 sample subsets of a selected model 302 from the set of models 301 to produce a subgraph 311. The sub-graph 311 includes a set of overlapped neighborhoods of vertices and edges of the selected model 302, i.e., a graph representing the d dimensional manifold embedded in ambient space [symbol] ^{D}. Sub-graph parameterizations 321 are determined 320 for a set of anchor vertices 312-315 selected from the subgraph. In the preferred embodiment, the anchor vertices are vertices on a perimeter of the subgraph, however the positions of anchor vertices are not limited to the perimeter. The subgraph parameterizations 321 are combined 330 with the input set of models 301 to identify a particular model 331.

As described above with respect to FIG. 2, when applying GNA to the original sample set 210, nullspaces of the isometric low-dimensional parameterizations are averaged to obtain a matrix having a nullspace containing a set of low-dimensional models 301 of the class of objects. Referring back to FIG. 3, the combining 330 according to an embodiment of the invention averages nullspaces of the sub-graph parameterizations 321 and nullspaces of the input set of models 301. Because the sub-graph parameterizations 321 are determined between samples separated by greater distances than the original sample subsets 221, eigenvalues that are not in the nullspace have a greater value after the combining 330, thereby increasing the eigengap between a particular model 331 and the remaining the set of models 301.

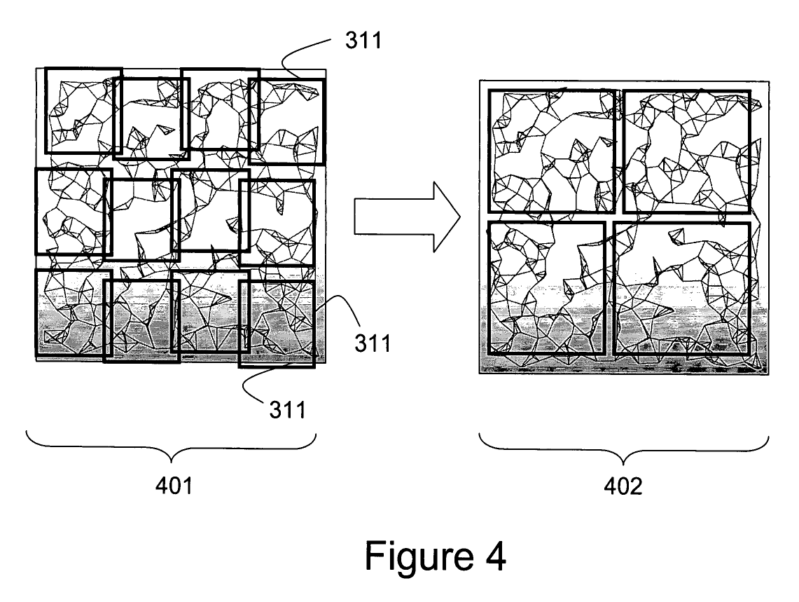

As shown in FIG. 4, the invention can be applied to an entire selected class model 302 by determining parameterizations for multiple sub-graphs 311 that approximately or entirely covers 401 the selected model 302 but adds constraints on just a small subset of all vertices, e.g., the anchor vertices. The parameterizations for the multiple sub-graphs are combined 330 in the same manner as shown in FIG. 3. Further sub-graph parameterizations 402 of increasing size can be applied to the selected model 302 in a recursive manner. Anchor vertices for larger size sub-graphs are selected only from anchor vertices from previous recursions.

In the preferred embodiment, a constant fraction of vertices are selected as anchor vertices for each sub-graph size, e.g., ¼ of the vertices are selected for each recursion independent of the size of the sub-graph.

If the number of sub-graphs and anchor vertices is halved at each recursion, then multiscale stiffening can be performed in O(N) time with no more than a doubling of the number of nonzeros in the K matrix.

Regularizing a Low-Dimensional Class Model Using Edge Length Constraints

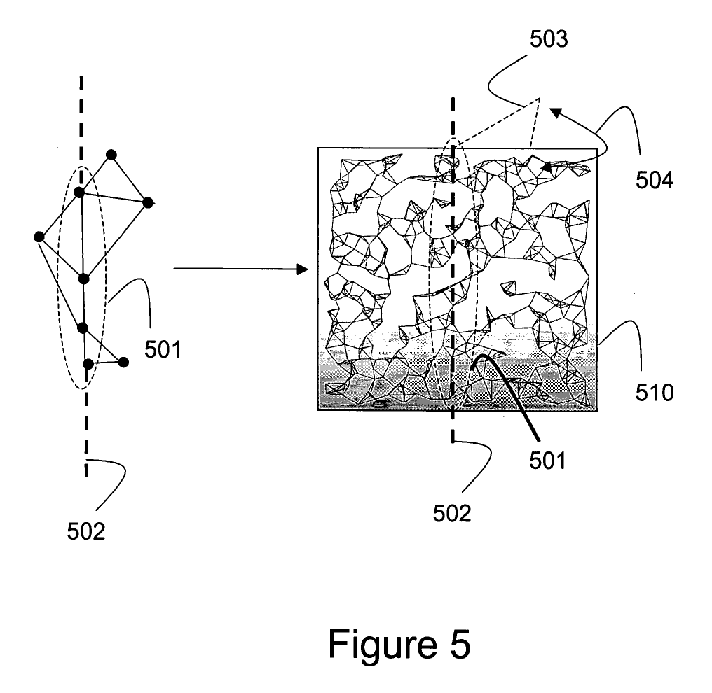

Even if a model, i.e., graph, is stiffened, it may be the case that the graph is intrinsically non-rigid. That commonly occurs when the graph is generated by a heuristic, such as k-nearest neighbors. In such cases, the embedding basis V∈R^{c×N} has greater dimension c than the target space [symbol] ^{d} (c>d). For example, as shown in FIG. 5, if a subset of vertices and edges 501 of a model 510 having d=2 are co-linear, they create an axis 502, which allows a variety of folds in the manifold in [symbol] ^{d}., e.g., fold 503 in the graph. In that case, the set of models span all possible folded configurations 504. Thus, the embedding is ill-posed, and regularization is needed to select a most unfolded model from the set of models.

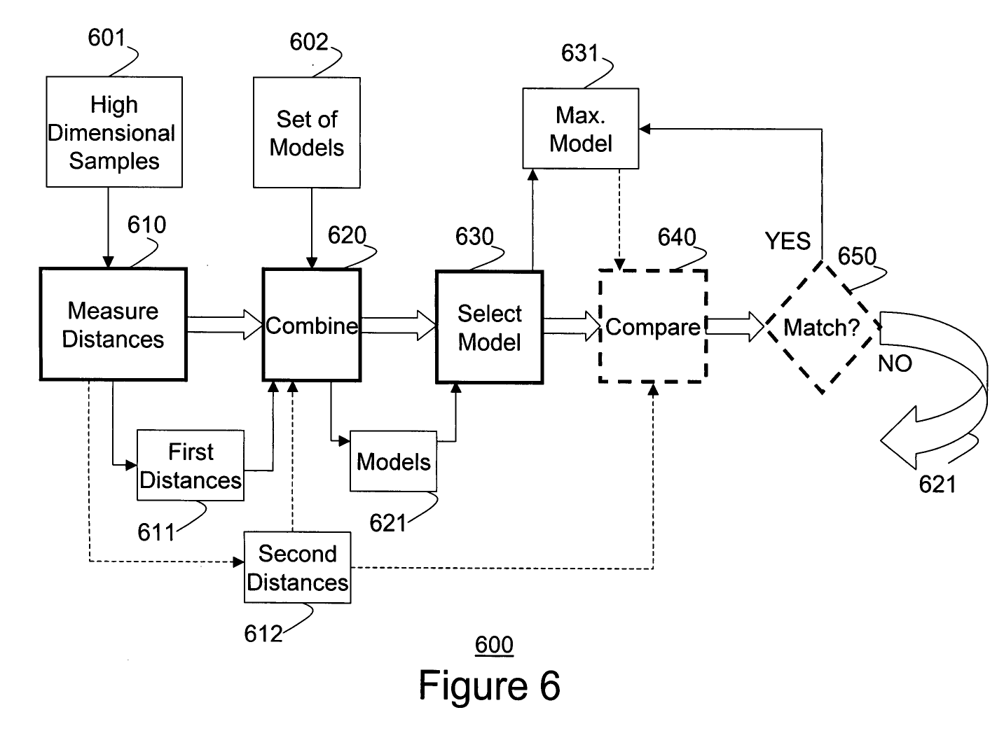

FIG. 6 shows a method 600 for selecting, from a set of models 602, a model 631 having maximally dispersed vertices, i.e., a most unfolded graph. First distances 611 between a subset of high dimensional samples 601 are measured 610. It should be understood that the high-dimensional samples correspond to vertices in the low-dimensional models. The first distances are combined 620 with the set of models. The combining 620 identifies a subset of models having distances between vertices, corresponding to the subset of high-dimensional samples, constrained by the first distances. In the preferred embodiment, the first distances identify a subset of models having edge lengths constrained by the first distances. A particular model 631 having maximized distances between all vertices is selecting 630 from the subset of models. In the preferred embodiment, distances between each vertex in the particular model and all 4-hop neighbors of each vertex are maximized. Thus, the most unfolded graph selected as the model satisfies the affine constraints encoded in the matrix K, maximizes distances between a mutually repelling subset of vertices, and satisfies exact distance constraints on some subset of edges.

Optionally, a second set of distances 612 between a second subset of the high-dimensional samples 601 can be compared 640 to corresponding distances, e.g. edge lengths, in the particular model 631. If distances between vertices, corresponding to the second subset of high-dimensional samples, are constrained by the second distances, there is a match 650 confirming the selection 630 of the particular model is correct. If there is not a match, the method is repeated 651, with the second distances 612 combined 620 with the set of models and the first distances.

Formally, a mixing matrix U∈R^{c×d} has orthogonal columns of arbitrary nonzero norm. An error vector σ=[σ₁, . . . ,σ_{c}]^{T} contains singular values of matrix K associated with its left singular vectors, i.e., the rows of embedding basis V. Mixing matrix U selects a metrically correct embedding from the space of possible solutions spanned by the rows of embedding basis V.

The target embedding, Y=[y₁, . . . ,y_{N}]≐U^{T}V∈ [symbol] ^{d×N}, has an overall distortion ∥U^{T}σ∥ and a distance ∥yᵢ−yⱼ∥=∥U^{T}(vᵢ−vⱼ)∥ between any two vertices (vᵢ being the ith column of embedding basis V). The optimization problem is to minimize distortion while maximizing the dispersion

$${U}^{*} = {max}_{U} - {‖ {U}^{⊤} σ ‖}^{2} + {\sum }_{pq}^{} {r}_{pq}^{2} {‖ {y}_{p} - {y}_{q} ‖}^{2} \qquad ( 1 )$$

for some choice of weights r_{pq}≧0, preserving distances
∀_{ij∈EdgeSubset}∥yᵢ−yⱼ∥≦Dᵢⱼ (2)

on at least d edges forming a simplex of nonzero volume in [symbol] ^{d}, otherwise the embedding can collapse in some dimensions. Edge lengths can be unequal because edge distances Dᵢⱼ, measured as straight-line distances, are chordal in the ambient space [symbol] ^{D} rather than geodesic in the manifold, and thus may be inconsistent with a low dimensional embedding.

The inequality allows some edges to be slightly shortened in favor of more dispersed, and thus flatter, lower-dimensional embeddings. Distance constraints corresponding to all or a random sample of the edges in the graph are enforced. The distance constraints do not have to form a connected graph.

The identity ∥Y∥_{F}²=∥U^{T}V∥_{F}²=trace(U^{T}VV^{T}U)=trace(VV^{T}UU^{T}) applied to equations 1-2 produces a semi-definite program (SDP) on objective G≐UU^{T} [symbol] 0:

$$\begin{matrix}{max }_{G} trace ( ( C - {diag ( σ )}^{2} ) G ) & ( 3 ) \\ with C \dot{=} {\sum }_{pq}^{} {r}_{pq}^{2} ( {v}_{p} - {v}_{q} ) {( {v}_{p} - {v}_{q} )}^{⊤} & ( 4 ) \\ {∀}_{i , j ∈ EdgeSubset} trace ( ( {v}_{i} - {v}_{j} ) {( {v}_{i} - {v}_{j} )}^{⊤} G ) \leq {D}_{ij}^{2} . & ( 5 )\end{matrix}$$

In particular, if all vertices repel equally (∀_{pq}r_{pq}=1), then C=VV^{T}=I, and trace

$$( CG ) = {\sum }_{pq}^{} {‖ {y}_{p} - {y}_{q} ‖}^{2} = {‖ Y ‖}_{F}^{2} .$$

Because V⊥1, the embedding is centered.

At the extreme of c=d, where U=T is an upgrade to isometry, the SDP is unnecessary. At c=D−1, semi-definite graph embedding is applied, where a range(V)=span( [symbol] ^{N}⊥1) replaces the centering constraints, thus LTSA/GNA is unnecessary. In between, there is a blend called Non-rigid Alignment (NA). With iterative eigensolving, LTSA/GNA takes O(N) time, but requires a globally rigid set of constraints. The semidefinite graph embedding does not require rigid constraints, but has O(N⁶) time scaling.

Non-Rigid Alignment

Non-rigid Alignment (NA) uses LTSA/GNA to construct an embedding basis that substantially reduces the semi-definite program. In addition, the option of combining an incomplete set of neighborhoods with an incomplete set of edge length constraints is possible, further reducing both problems. Although this method does require an estimate of the local dimension for the initial LTSA/GNA, the method inherits from semidefinite graph embeddings the property that the spectrum of higher dimensional data X gives a sharp estimate of the global embedding dimension, because the embedding is spanned by embedding basis V. The local dimension can be over-estimated, which reduces the local nullspace dimension and thus the global rigidity, but the additional degrees of freedom can then be fixed in the SDP problem.

Reducing the SDP constraints

The SDP equality constraints can be rewritten in matrix-vector form as A^{T}svec(G)=b, where svec(G) forms a column vector from the upper triangle of X with the off-diagonal elements multiplied by \sqrt{2}. Here each column of constraint matrix A contains a vectorized edge length constraint (e.g., svec((vᵢ−vⱼ)(vᵢ−vⱼ)^{T}) for an equality constraint) for some edge i⇄j; the corresponding element of vector b contains the value Dᵢⱼ². A major cost of the SDP solver lies in operations on the matrix A∈R^{c}^{²}^{×e}, which may have a large number of linearly redundant columns.

When the problem has an exact solution (equation 5 is feasible as an equality), this cost can be reduced by projection: Let F∈R^{e×f}, f<<e be a column-orthogonal basis for the principal row-subspace of constraint matrix A, which can be estimated in O(ef²c²) time via thin SVD. From the Mirsky-Eckart theorem it follows that the f equality constraints,
F^{T}A^{T}vec(G)=F^{T}b (6)
are either equivalent to or a least-squares optimal approximation of the original equality constraints. For large, exactly solvable problems, it is not unusual to reduce the cardinality of constraint set by 97% without loss of information.

When the problem does not have an exact solution, i.e., equation 5 is only feasible as an inequality, the SDP problem can be solved with a small subset of randomly chosen edge length inequality constraints. In conjunction with the affine constraints imposed by the subspace V, this suffices to satisfy most of the remaining unenforced length constraints. Those that are violated can be added to the active set and the SDP re-solved, repeating until all are satisfied.

Application to Speech Data

The TIMIT speech database is a widely available collection of audio waveforms and phonetic transcriptions for 2000+ sentences uttered by 600+ speakers. One application of the invention models the space of acoustic variations in vowel sounds. Starting with a standard representation, a vector of D=13 mel-cepstral features is determined for each 10 millisecond frame that was labeled as a vowel in the transcriptions.

To reduce the impact of transcription errors and co-articulatory phenomena, the data are narrowed to the middle half of each vowel segment, yielding roughly N=240,000 samples in R13. Multiple applications of PCA to random data neighborhoods suggested that the data is locally 5-dimensional. An NA embedding of the 7 approximately-nearest neighbors graph with 5-dimensional neighborhoods and a 25-dimensional basis took slightly less than 11 minutes to determine. The spectrum is sharp, with >99% of the variance in 7 dimensions, >95% in 5 dimensions, and >75% in 2 dimensions.

A PCA rotation of the raw data matches these percentages at 13, 9, and 4 dimensions respectively. Noting the discrepancy between the estimated local dimensionality and global embedding dimension, slack variables with low penalties were introduces to explore the possibility that the graph was not completely unfolding.

A longstanding rule-of-thumb in speech recognition is that a full-covariance Gaussian is competitive with a mixture of 3 or 4 diagonal-covariance Gaussians [LRS83]. The important empirical question is whether the NA representation offers a better separation of the classes than the PCA. This can be quantified (independently of any downstream speech processing) by fitting a Gaussian to each phoneme class and calculating the symmetrized KL-divergence between classes.

Higher divergence means that fewer bits are needed to describe classification errors made by a (Gaussian) quadratic classifier. The divergence between classes in the d=5 NA representation was on average approximately 2.2 times the divergence between classes in the d=5 PCA representation, with no instances where the NA representation was inferior. Similar advantages were observed for other values of d, even, d=1 and d=D.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. (canceled)

2. A computer implemented method for selecting a particular model from a set of models, the set of models representing a class of objects, in which each model is a graphs, and in which each graph includes a plurality of vertices connected by edges, and in which the vertices represent high-dimensional samples of the objects in the class and the edges connecting the vertices represent distances between the high-dimensional samples, comprising the steps of:
measuring first distances between a subset of high-dimensional samples of the objects in the class;
combining the first distances with a set of low-dimensional models of the class to produce a subset of models constrained by the first distances; and
selecting, from the subset of models, a particular model having vertices that are maximally dispersed.

3. The method of claim 1, in which the objects are images of faces.

4. The method of claim 1, in which the objects are speech sounds.

5. The method of claim 1, further comprising:
generating the set of models using a non-linear dimensionality reduction of samples the objects.

6. The method of claim 5, in which the non-linear dimensionality reduction uses geodesic nullspace analysis.

7. The method of claim 1, in which the high-dimensional samples are pixel intensities in images.

8. The method of claim 1, in which the set of anchor vertices are on a perimeter of the subgraph.

9. The method of claim 1, further comprising:
measuring second distances between the high-dimensional samples;
combining the second distances with the set of low-dimensional models to identify a second subset of the models having the distances between the high-dimensional samples constrained by the first distances;
comparing the second distances with the first distances of the particular model;
confirming the selection of the particular model if the first distances and the second distance match; and otherwise
repeating the measuring, combining and comparing until the first distances and the second distances match.

10. The method of claim 1, in which the high-dimensional samples are mel-cepstral features determined from frames of speech labeled as a vowel.
